(19) United States
(12) Patent Application Publication
(10) Pub. No.: US 2026/0049765 A1
(43) Pub. Date: Feb. 19, 2026

(54) Apparatus and Method for Spray-Freeze Drying (SFD) of Microalgae

(71) Applicant: Geb Impact Technology Company Limited, Hong Kong (HK)

(72) Inventor: Zhonghui Alex WANG, Hong Kong (HK)

(21) Appl. No.: 18/804,278

(22) Filed: Aug. 14, 2024

(51) Int. Cl. F26B 5/06; F26B 3/28; F26B 9/06

(52) U.S. Cl. CPC F26B 5/065; F26B 3/28; F26B 9/06; F26B 2200/16

(57) ABSTRACT

Disclosed is a spray-freeze drying (SFD) apparatus for continuous drying of microalgae. The apparatus includes a main chamber connected to a collector chamber and a compressor, designed to freeze fine droplets of microalgae and collect frozen particles. A drying chamber, positioned downstream of the main chamber, is coupled with a vacuum pump and an electromagnetic radiation source to remove moisture from the frozen microalgae, resulting in dried particles. The dried microalgae are then collected in a designated collection chamber. Additionally, a method is disclosed for continuous drying of microalgae using the SFD apparatus. The method involves spraying microalgae suspension as fine droplets towards a cold surface particle collector in the main chamber, freezing and collecting the particles, transferring them to the drying chamber, and removing moisture through the activation of the electromagnetic radiation source and vacuum pump, followed by collecting the dried microalgae in the collection chamber.

### CROSS-REFERENCE TO RELATED APPLICATIONS

Not applicable.

### FIELD OF THE INVENTION

The present invention relates to biotechnology and food technology, particularly to an apparatus and method for preserving and processing biological materials. More specifically, it pertains to a spray-freeze drying (SFD) apparatus designed for the continuous drying of microalgae suspensions.

### BACKGROUND OF THE INVENTION

Spray Freeze-Drying (SFD) has garnered significant attention by merging the principles of spray drying and freeze-drying to create stable dry powders with controlled particle sizes and improved stability. By combining the benefits of these two well-established methods, SFD shows great potential for large-scale continuous production of food and pharmaceutical products, especially those that require careful handling of volatile compounds and bioactive components.

SFD allows for precise control over particle size and enhanced product stability. The process starts with the atomization of a liquid solution, breaking it down into smaller droplets. These droplets are rapidly frozen using a cryogen, typically liquid nitrogen. This step solidifies the droplets, preserving the integrity of sensitive components and preventing the formation of large ice crystals. Subsequently, the frozen droplets undergo sublimation under low temperature and pressure conditions, resulting in the production of dry, powdered products.

SFD offers several distinct advantages that make it an attractive option for biotechnology manufacturing. One of the key benefits is the improved retention of volatile compounds and sensitive components, which is often compromised by conventional drying methods. Additionally, SFD's capability to better preserve product quality and bioactive compounds ensures the potency of pharmaceutical formulations. Another noteworthy advantage is the reduced processing time compared to traditional drying methods, which offers a critical factor in efficient mass manufacturing processes.

Various continuous SFD methods are being explored, each with unique features and benefits. Concepts such as Rey's heated conveyor, dynamic freeze-drying with spray freezing, fine-spray freeze-drying, stirred freeze-drying, and Lynfinity's aseptic production system are representative of the ongoing developments in the field.

While SFD presents an array of advantages, there are notable challenges that need to be addressed. Potential issues such as protein denaturation and phase separation are concerns that require careful process optimization and formulation considerations. Precise control over particle size and distribution is another challenge, demanding fine-tuning of atomization techniques and parameters. The complexity of scaling up the SFD process and integrating it into existing manufacturing operations poses further challenges. Additionally, the high-energy requirements for atomization, although inherent to the atomization process, should be considered in the context of overall process efficiency.

For example, US20110016742A1 describes an apparatus and method for spray freeze drying materials containing solid and aqueous portions, focusing on precise control over the thickness of the frozen layer during the process. WO2017084162A1 introduces a fully automatic sealed-type spray-freeze-drying production equipment and method that aims to maintain sterility and continuity during the spray-freeze-drying production process. U.S. Pat. No. 7,363,726 outlines a method of creating a dry powder using spray freeze drying, offering several variations of the method. This patent's focus is on the general process of creating dry powders using spray freeze drying and does not specifically emphasize microalgae. Whilst all three patents have their own advantages, however, the complex techniques employed in both inventions are not cost-effective for a large-scale production of dried microorganisms.

CN217979534U disclosed a vacuum spray freeze dryer, including feed arrangement, vacuum drying device, wherein the feed arrangement includes charge pump and preliminary treatment mechanism. However, the single column vacuum cavity in this invention is designed with multiple temperature zones i.e., to freeze the sprayed biomass droplets and to dry them during the free fall once being crystallised. It is very conceptual, but not practical for microalgae, when the freezing and drying of the cell body need longer time.

Generally, current microalgae drying techniques face several challenges. One of the key issues is energy consumption, as many methods require high temperatures or significant energy inputs, making the process economically unsustainable and environmentally unfriendly. Additionally, maintaining the viability and nutritional value of microalgae during drying remains a significant concern, as traditional methods can lead to nutrient loss and reduced product quality. Furthermore, the scalability of drying processes for large-scale microalgae production is a critical hurdle, as efficient and cost-effective techniques suitable for commercial production are still under development.

### SUMMARY OF THE INVENTION

It is an objective of the present invention to provide a system and method to overcome the shortcomings of existing microalgae drying technologies, particularly addressing the issues of high energy consumption, nutrient loss, and scalability.

It is also an objective of the present invention to provide a system and method to enhance the efficiency of the drying process for microalgae, maintain the viability and nutritional value of microalgae and ensure precise control over particle size and distribution of the microalgae during the drying process.

Accordingly, these objectives can be achieved by following the teachings of the present invention, which relates to a spray-freeze drying (SFD) apparatus for continuous drying of microalgae, the device comprising: a main chamber coupled to a collector chamber and a compressor, configured to freeze fine droplets of the microalgae and collect the frozen microalgae; a drying chamber connected downstream of the main chamber coupled to a vacuum pump and an electromagnetic radiation source configured to remove moisture from the frozen microalgae and form dried microalgae; and, a collection chamber configured to collect the dried microalgae from the drying chamber.

These objectives can also be achieved by following the teachings of the present invention, which relates to a method for drying of microalgae continuously using a spray-freeze drying apparatus, wherein the method comprising: freezing the microalgae by spraying fine droplets of microalgae suspension towards a cold surface particle collector using a spray nozzle in a main chamber; collecting frozen microalgae from the cold surface particle collector; transferring the frozen microalgae to a drying chamber; removing moisture from the frozen microalgae by activating an electromagnetic radiation source and a vacuum pump; and, collecting the dried microalgae in the collection chamber.

### BRIEF DESCRIPTION OF DRAWINGS

The features of the invention will be more readily understood and appreciated from the following detailed description when read in conjunction with the accompanying drawings of the preferred embodiment of the present invention, in which:

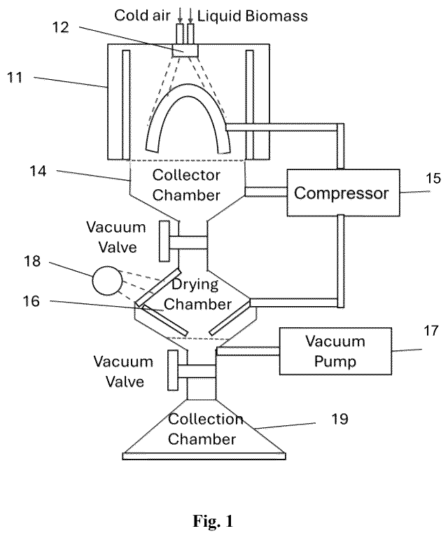

### FIG. 1 illustrates an embodiment of the present invention.

### DETAILED DESCRIPTION OF THE INVENTION

For the purposes of promoting and understanding the principles of the invention, reference will now be made to the embodiments illustrated in the drawings and described in the following written specification. It is understood that the present invention includes any alterations and modifications to the illustrated embodiments and includes further applications of the principles of the invention as would normally occur to one skilled in the art to which the invention pertains.

The present invention teaches a spray-freeze drying (SFD) apparatus for continuous drying of microalgae, the device comprising: a main chamber 11 coupled to a collector chamber 14 and a compressor 15, configured to freeze fine droplets of the microalgae and collect the frozen microalgae; a drying chamber 16 connected downstream of the main chamber 11 coupled to a vacuum pump 17 and an electromagnetic radiation source 18, configured to remove moisture from the frozen microalgae and form dried microalgae; and, a collection chamber 19 configured to collect the dried microalgae from the drying chamber 16.

In one aspect of the present invention, the main chamber 11 further comprising: a spray nozzle 12 having compressed cold air configured to break wet microalgae into uniform and fine microalgae; and, a cold surface particle collector 13 positioned within or adjacent to the collector chamber 14 for rapidly freezing the microalgae upon contact.

In one aspect of the present invention, the electromagnetic radiation source 18 includes but is not limited to infrared radiation (IR) configured to supply sublimation energy during the drying of the microalgae.

In one aspect of the present invention, the microalgae are high-viscosity microalgae.

In one aspect of the present invention, the compressor 15 maintains a low temperature environment within the main chamber 11.

In one aspect of the present invention, the cold surface particle collector 13 is a cold retractable surface maintained at a temperature sufficient to freeze the microalgae upon contact.

In one aspect of the present invention, the drying chamber 16 is further configured to transition the frozen microalgae directly from a solid to a gaseous state under reduced pressure, resulting in dried microalgae.

In one aspect of the present invention, the vacuum pump 17 is operatively connected to the drying chamber 16 for reducing pressure to facilitate sublimation of the frozen microalgae.

The present invention teaches also teaches a method for drying of microalgae continuously using a spray-freeze drying apparatus, wherein the method comprising: freezing the microalgae by spraying fine droplets of microalgae suspension towards a cold surface particle collector 13 using a spray nozzle 12 in a main chamber 11; collecting frozen microalgae from the cold surface particle collector 13 by activating a compressor 15; transferring the frozen microalgae to a drying chamber 16; removing moisture from the frozen microalgae by activating an electromagnetic radiation source 18 and a vacuum pump 17; and, collecting the dried microalgae in the collection chamber 19.

In one aspect of the present invention, the fine droplets of the microalgae suspension are frozen rapidly upon contact with the cold surface particle collector 13 to prevent agglomeration and ensure uniform drying.

In one aspect of the present invention, the step of freezing the microalgae by spraying fine droplets of microalgae suspension towards the cold surface particle collector 13 using the spray nozzle 12 in the main chamber 11 further comprising removing moisture from microalgae cells extracellularly, through a controlled sublimation or evaporation technique.

In one aspect of the present invention, the step of removing moisture from the frozen microalgae by activating the electromagnetic radiation source 18 and the vacuum pump further comprising removing moisture from the microalgae cells intracellularly, through a controlled heating technique to promote cellular dehydration.

The present invention explained above is not limited to the aforementioned embodiment and drawings, and it will be obvious to those having an ordinary skill in the art of the prevent invention that various replacements, deformations, and changes may be made without departing from the scope of the invention.

1. A spray-freeze drying (SFD) apparatus for continuous drying of microalgae, the device comprising:
a main chamber coupled to a collector chamber and a compressor, configured to freeze fine droplets of the microalgae and collect the frozen microalgae;
a drying chamber connected downstream of the main chamber coupled to a vacuum pump and an electromagnetic radiation source, configured to remove moisture from the frozen microalgae and form dried microalgae; and
a collection chamber configured to collect the dried microalgae from the drying chamber.

2. The apparatus according to claim 1, the main chamber further comprising:
a spray nozzle having compressed cold air configured to break wet microalgae into uniform and fine microalgae; and
a cold surface particle collector positioned within or adjacent to the collector chamber for rapidly freezing the microalgae upon contact.

3. The apparatus according to claim 1, wherein the electromagnetic radiation source (18) includes but is not limited to infrared radiation (IR) configured to supply sublimation energy during the drying of the microalgae.

4. The apparatus according to claim 1, wherein the microalgae are high-viscosity microalgae.

5. The apparatus according to claim 1, wherein the compressor maintains a low temperature environment within the main chamber.

6. The apparatus according to claim 2, wherein the cold surface particle collector is a cold retractable surface maintained at a temperature sufficient to freeze the microalgae upon contact.

7. The apparatus according to claim 1, wherein the drying chamber is further configured to transition the frozen microalgae directly from a solid to a gaseous state under reduced pressure, resulting in dried microalgae.

8. The apparatus according to claim 1, wherein the vacuum pump is operatively connected to the drying chamber for reducing pressure to facilitate sublimation of the frozen microalgae.

9. A method for drying of microalgae continuously using a spray-freeze drying apparatus, the method comprising:
freezing the microalgae by spraying fine droplets of microalgae suspension towards a cold surface particle collector using a spray nozzle in a main chamber (11);
collecting frozen microalgae from the cold surface particle collector into a collector chamber by activating a compressor;
transferring the frozen microalgae to a drying chamber;
removing moisture from the frozen microalgae by activating an electromagnetic radiation source and a vacuum pump; and
collecting the dried microalgae in the collection chamber.

10. The method according to claim 9, wherein the fine droplets of the microalgae suspension are frozen rapidly upon contact with the cold surface particle collector to prevent agglomeration and ensure uniform drying.

11. The method according to claim 9, wherein the step of freezing the microalgae by spraying fine droplets of microalgae suspension towards the cold surface particle collector using the spray nozzle in the main chamber further comprises removing moisture from microalgae cells extracellularly, through a controlled sublimation or evaporation technique.

12. The method according to claim 9, wherein the step of removing moisture from the frozen microalgae by activating the electromagnetic radiation source and the vacuum pump further comprises removing moisture from the microalgae cells intracellularly, through a controlled heating technique to promote cellular dehydration.
